(19) United States
(12) Patent Application Publication
(10) Pub. No.: US 2010/0106541 A1
(43) Pub. Date: Apr. 29, 2010

(54) Analyzing the Readiness of a Template

(75) Inventors: Anadi Upadhyaya, Hyderabad (IN); Ty Hayden, Grand Junction, CO (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/259,452

(22) Filed: Oct. 28, 2008

(51) Int. Cl. G06Q 10/00; G06F 17/00; G06F 11/07

(52) U.S. Cl. 705/7; 715/235; 714/37; 714/E11.024

(57) ABSTRACT

Systems and methods for managing templates are described herein. According to one embodiments, a method comprises applying information into a proposed template. In particular, the information is received for the purpose of filling blank portions of the proposed template. The method further comprises performing a readiness analysis on the proposed template to determine whether or not the proposed template is ready to be used by one or more users based on the application of the information into the proposed template.

### TECHNICAL FIELD

The present disclosure describes embodiments generally related to managing employee compensation information. More particularly, the present disclosure relates to determining the readiness of a template for communicating compensation changes to an employee.

### BACKGROUND

Many of the same types of tasks within an organization are repeated over the course of time by a number of employees in some way or another. With respect to the task of creating similar type documents, an organization may wish to standardize the documents in order to create a consistent product. In order to minimize the redundancy involved with generating the same letters and forms, organizations often create templates that can be used as a starting point for letters, forms, etc., that are used frequently within the organization. Therefore, instead of requiring each employee to generate a letter or form from scratch, the employees can begin with a previously created template and fill in the necessary information as needed. In this manner, much time can be saved within a corporation by allowing employees to access templates to complete the task of creating standard documents.

### SUMMARY

The present disclosure describes systems and methods for managing templates. In one embodiment, among others, a method comprises applying information into a proposed template, wherein the information is received for the purpose of filling blank portions of the proposed template. The method also comprises performing a readiness analysis on the proposed template to determine whether or not the proposed template is ready to be used by one or more users. The readiness analysis is based on the application of the information into the proposed template.

Other features, advantages, and implementations of the present disclosure, not expressly disclosed herein, will be apparent to one of ordinary skill in the art upon examination of the following detailed description and accompanying drawings. It is intended that such implied implementations of the present disclosure be included herein.

### BRIEF DESCRIPTION OF THE DRAWINGS

The components of the following figures are illustrated to emphasize the general principles of the present disclosure. Reference characters designating corresponding components are repeated as necessary throughout the figures for the sake of consistency and clarity.

FIG. 1 is a block diagram illustrating an employee compensation managing system according to one embodiment.

FIG. 2 is a block diagram illustrating a template managing module according to one embodiment.

FIG. 3 is a diagram of a user interface for performing setup functions according to one embodiment.

FIG. 4 is a diagram of a user interface for configuring employee statements according to one embodiment.

FIG. 5 is a diagram of the user interface of FIG. 4 and a superimposed error window according to one embodiment.

FIG. 6 is a diagram of a user interface for communicating compensation changes to one or more employees according to one embodiment.

FIG. 7 is a flow diagram illustrating a method for setting up compensation templates according to one embodiment.

FIG. 8 is a flow diagram illustrating a method for using compensation templates according to one embodiment.

### DETAILED DESCRIPTION

Organizations often create document templates that can be used by a number of employees to generate specific standard documents. The purpose of templates is to reduce the redundancy of work that has already been done by someone else in the organization. Instead, employees can access a particular template from the organization's network and fill in the pertinent information for the specific situation.

However, it is known that the use of some templates do not always produce acceptable results. For instance, some templates include information that is not necessary for the particular situation in which the template is being used. Occasionally, a template will apply to one group of people but not to another. Another problem that often results from the use of templates is poor grammar, such as the disagreement between nouns, which are entered into the template, and the corresponding verbs. These and other problems are common when templates are used.

To overcome many of these problems, a person using a template often needs to check the resulting letter or form to see if any of these common problems have occurred. Consequently, the person can lose confidence in the effectiveness of the template. Also, the person may be required to spend valuable time checking how the entered information is handled in the template and if any of the above problems or other problems arise. If problems are detected, the person usually must edit the document to correct the discovered errors. Otherwise, if a letter or form that is created by a template inherently includes errors, then the letter or form can give a negative impression of the organization and may not be taken seriously by people reading the improperly formed letters or forms.

According to the embodiments described in the present disclosure, templates can be created and then automatically analyzed to detect common errors that occur with respect to many templates. After the template is checked for readiness, the systems and methods described herein can avow that the template is ready for use. Once avowed, the template can be accessed and used by the employees as needed. Furthermore, the employees can use the templates with the confidence that the template will not produce an unacceptable product, which can be common with other unchecked templates.

In particular, the embodiments of the present disclosure relate to systems and method for managing the compensation information for the employees of an organization. When a compensation change is planned to go into effect for an employee, any number of managers, administrators, etc., may get involved to determine the details of the compensation change. Some changes may need to be sent up the chain of hierarchy for approval. With respect to one example, if an employee works for an organization for a certain number of years, the organization may have systems in place to reward the employee by paying the employee a bonus and/or increasing the employee's pay. When these or other types of changes are planned, organizations usually communicate the changes to the employee.

The compensation management systems described herein can be configured, for example, to produce a communication letter or statement that is intended to be given to an employee when a change in compensation, e.g., raise, bonus, stock options, etc., is going into effect. The communication is usually given to the employee for the employee's own information and records. Each organization may contain their own wording for these types of letters to communicate information to the employees as the management deems to be appropriate.

It should be noted, however, that although the embodiments described herein pertain particularly to communicating compensation changes to an employee, these embodiments can also pertain to the creation of any type of document, communication, statement, letter, etc., from a template. A non-limiting list of other applications may include letters regarding other types of personnel actions, confirmation of a change in the employee's address or contact information, confirmation of a change of a client's contact information, information about a client's account, a letter communicating one or more pieces of information to a client, etc.

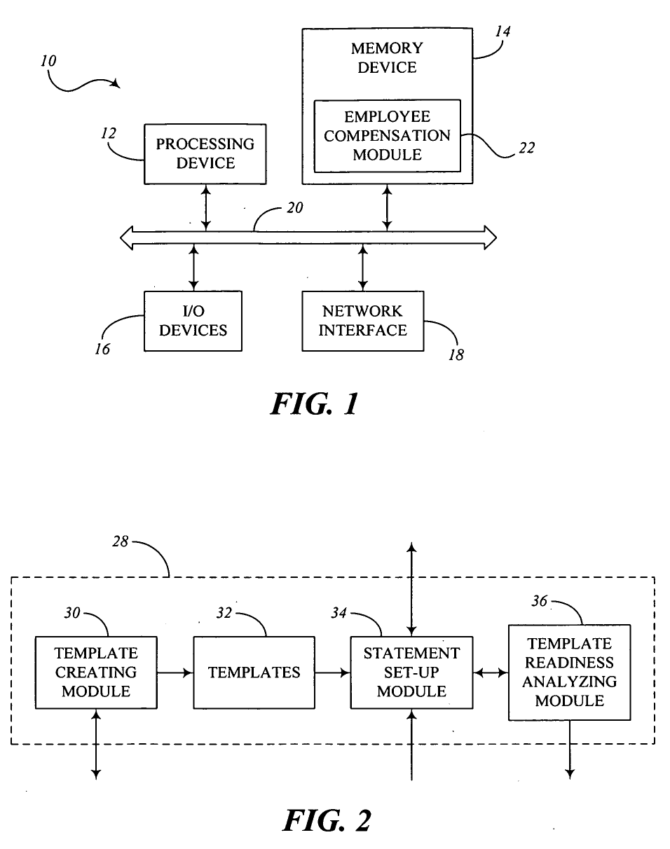

FIG. 1 is a block diagram of an embodiment of an employee compensation managing system 10. Employee compensation managing system 10 may represent any type of system that may be used within an organization, business, enterprise, government agency, department, group, etc. Particularly, employee compensation managing system 10 may be a computer system, data processing system, or other suitable electronic device for executing logic instructions, e.g., software applications. Employee compensation managing system 10 can be connected to a network associated with an organization.

In the embodiment of FIG. 1, employee compensation managing system 10 includes a processing device 12, a memory device 14, input/output (I/O) devices 16, and network interface 18, each interconnected via a bus interface 20. In this embodiment, memory device 14 is configured to store an employee compensation module 22. Processing device 12 may be a general-purpose or specific-purpose processor or microcontroller. Memory device 14 may include one or more internally fixed storage units, removable storage units, and/or remotely accessible storage units. The storage units can be configured to store information, data, instructions, and/or software code. The storage units may include any suitable combination of volatile memory and/or non-volatile memory.

Memory device 14 can also store program code that enables processing device 12 to execute procedures related to the management of compensation information for one or more employees. The embodiments of employee compensation module 22 described in the present disclosure can be implemented in hardware, software, firmware, or a combination thereof. When implemented in software or firmware, employee compensation module 22 is stored in memory device 14, as illustrated, and executed by processing device 12. Alternatively, when implemented in hardware, an employee compensation system can be implemented in processing device 12 using discrete logic circuitry, an application specific integrated circuit (ASIC), a programmable gate array (PGA), a field programmable gate array (FPGA), other suitable logic circuit, or any combination thereof.

Employee compensation module 22 may include similar logic stored on a number of different systems in communication over the network and may be capable of communicating with each other via their respective network interfaces, such as network interface 18. In some embodiments, certain employees, such as compensation administrators, can include authorization to perform certain functions of employee compensation module 22 that are not authorized to other employees. In this respect, employee compensation module 22 can be stored partially or fully in memory device 14 in each respective employee compensation managing system 10.

In addition, other software, programs, or computer code including executable logical instructions as described herein, can be embodied in computer-readable media for execution by any suitable processing device, such as processing device 12. The computer-readable media as described herein can include one or more suitable physical media components that can store the software, programs, or computer code for a measurable length of time.

Input/output devices 16 may include input mechanisms such as keyboards, keypads, cursor control devices, or other data entry devices. The input mechanisms enable a user to enter information for creating templates, information regarding compensation plans, information to be added to a template, requests for creating a statement, etc. The applicable entries may depend on the employee's roles in the organization. Input/output devices 16 also include output mechanisms, such as computer monitors, audio output devices, printers, or other peripheral devices for communicating information to the user.

FIG. 2 is a block diagram of an embodiment of a template managing module 28. Template managing module 28 may be one of several modules embedded in employee compensation module 22 shown in FIG. 1. In this embodiment, template managing module 28 includes a template creating module 30, templates 32, a statement set-up module 34, and a template readiness analyzing module 36. In general, template managing module 28 is configured to manage templates for the generation of statements or letters that are sent to employees regarding compensation changes for the respective employees.

One or more people of a group of users, such as compensation administrators in charge of handling compensation matters for employees of an organization, can use template creating module 30 for creating one or more templates to be used within the organization. Template creating module 30 allows the users to enter text that is intended to be included in a particular template. Templates can be entered using any suitable format, such as, for example, portable document format (“PDF”), rich text format (“RTF”), etc. Also, the templates can be defined using any suitable editor that supports the particular format.

Also, template creating module 30 allows the users to enter conditional text that is included in the statement or letter when certain conditions are met. In this way, only the applicable phrases, sentences, paragraphs, etc. will be entered in the statement or letter. Furthermore, template creating module 30 allows the users to enter locations in the statement or letter where variable information is inserted. For example, the variable information may include the employee's name, employee's contact information, employee's job, current date, effective date of compensation change, prior salary, new salary, bonus amount, stock option amount, or other compensation type information. When the templates are created with template creating module 30, templates 32 are stored for later editing or use. Before being used, however, templates 32 can be applied to statement set-up module 34 for validation of the adequacy of templates 32.

The users can then enter one or more compensation plans to statement set-up module 34. The compensation plans may include various hypothetical conditions of compensation changes. In other embodiments, the compensation plans may represent actual compensation changes proposed for one or more employees. With the entered compensation plans, statement set-up module 34 applies the compensation plans to the appropriate template 32 and forms the statement, letter, form, etc., resulting in a combination of the template and the information of the compensation plan.

When the statement is set-up by statement set-up module 34, template readiness analyzing module 36 is configured to analyze the resulting statement to see if the template properly handled the compensation information. If it is determined that the statement meets certain conditions that are checked by template readiness analyzing module 36, a message is sent from template readiness analyzing module 36 to the user, who entered the compensation plan, avowing or indicating that the template is ready. Template readiness analyzing module 36 can be used to check for the most common errors or oversights that are found in templates. By checking for these errors before validation of the template, the errors can be corrected prior to use by other users within the organization.

One example of a common error in templates includes the use of an incorrect template format. For example, if the template is created in one format and is later renamed or edited using another format, then a corrupted output can occur. Another example of a possible error is the inclusion of phrases, sentences, or paragraphs of the letter or statement that are not applicable to the employee's situation. For example, if an employee is due to receive a salary increase but not a year-end bonus, then it may be inappropriate to include a sentence or paragraph stating that the employee's bonus is $0. Generally, conditional logic is inserted in the template to handle such a scenario. In this case, template readiness analyzing module 36 may be used to validate the conditional logic in order to correct the syntax as needed and to avoid the conditions like the one mentioned above.

Template readiness analyzing module 36 is also capable of detecting other errors, such as errors in syntax regarding conditional logic, errors in grammar, etc. In response to discovering these and/or other errors, template readiness analyzing module 36 can report the errors to the person who created the template to avoid usage of a template that would require much re-work by each user thereafter. If the template does not meet all the criteria, then an error message is sent to indicate that the template is not ready and must be changed. In some embodiments, template readiness analyzing module 36 can provide helpful suggestions explaining how the template can fixed.

As illustrated in FIG. 2, template readiness analyzing module 36 is embedded in template managing module 28. Therefore, template readiness analyzing module 36 can detect issues as the templates are created so that any errors can be resolved before the template is ready for use. This can eliminate the need for a client tool to correct these errors. Also, it can save time for the users of the template and thereby reduce costs.

In response to an indication that the template is not ready, the user can access the template creating module 30 to make appropriate modifications to the template to overcome the errors that were reported by template readiness analyzing module 36. After modifications are made, the user can again run compensation plans through statement set-up module 34 for creating the statement from the combination of the compensation information and the modified template. Again, template readiness analyzing module 36 checks the statement for the particular list of errors and determines whether the template is ready for use or if further modifications are needed.

When templates 32 are eventually avowed by template readiness analyzing module 36 as being ready for use, another group of users, such as managers, line managers, or other employees, can use templates 32 as needed. A user of this group can enter a request to access the statement that was created from the compensation information and corresponding template in response to the compensation administrator entering and verifying the templates and statements. In other embodiments, the line manager or other user can enter a request to access a selected template and enter new compensation information to be applied to the template. This information is applied to statement set-up module 34, which sets up the statement or letter according to the design of the template. Once the statement is generated, statement set-up module 34 sends a copy to the user. This statement can then be printed by the user or communicated to the specific employee as necessary.

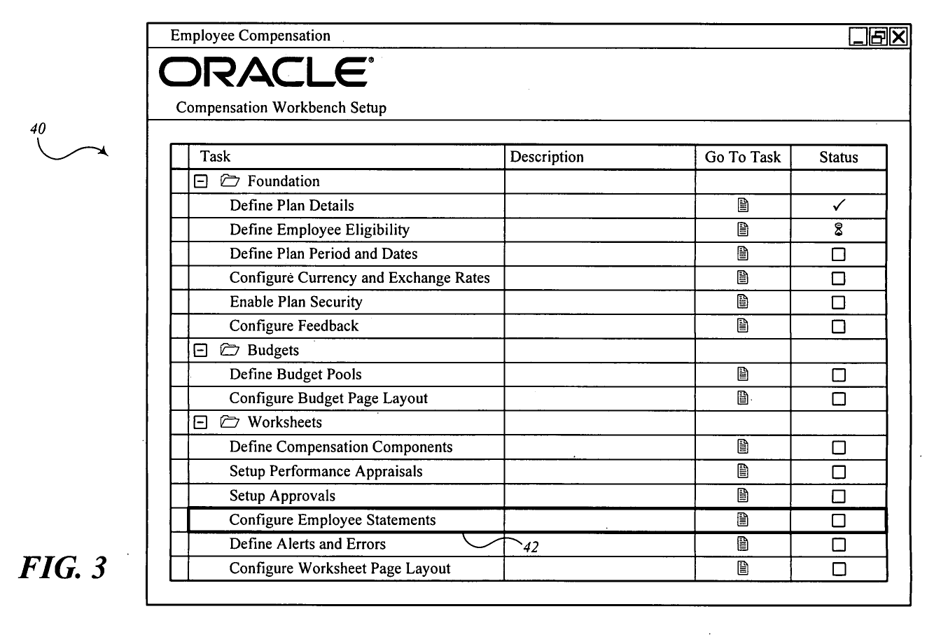

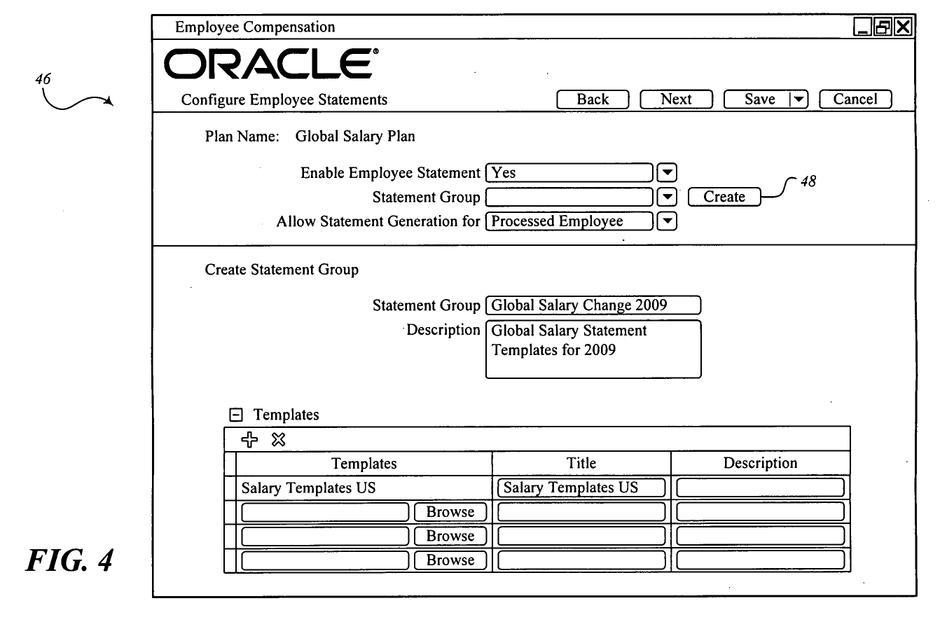

FIG. 3 is a diagram illustrating an embodiment of a user interface 40 for enabling a user to define aspects of employee compensation. In the embodiment of FIG. 3, user interface 40 includes several categories for performing certain tasks. Under each task is a number of sub-categories that can be selected for enabling the user to define aspects of the tasks. For example, under “Worksheets”, one of the selections is “Configure Employee Statements” 42, allowing a user to control how statements, which are intended to communicate compensation changes to one or more employees, are configured. In some embodiments, the action of configuring employee statements may be associated with template managing module 28 of FIG. 2 and/or other modules of employee compensation module 22 shown in FIG. 1. When Configure Employee Statements 42 is selected, another user interface, as described below with respect to FIG. 4, is presented.

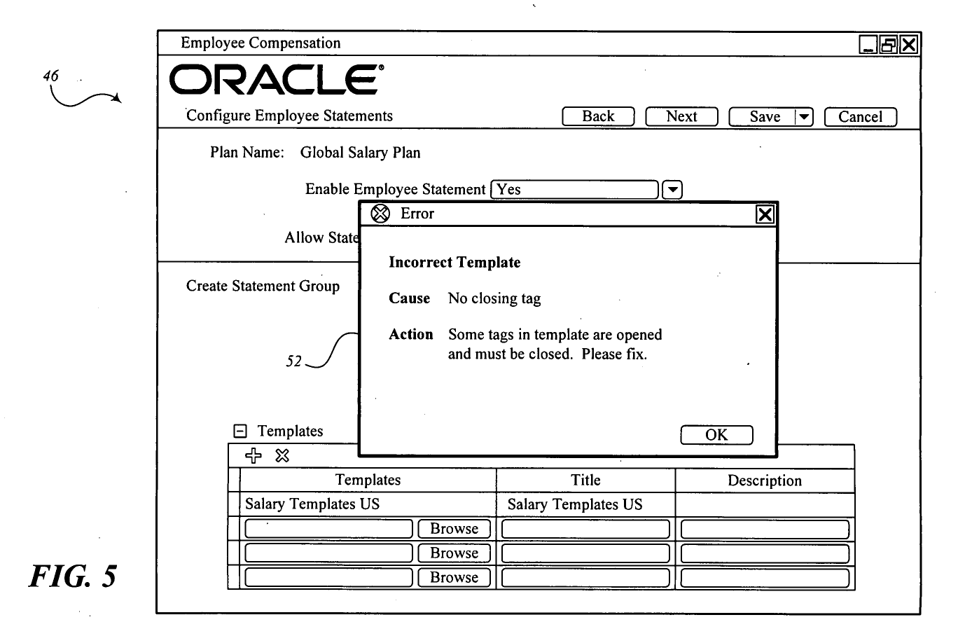

FIG. 4 is a diagram illustrating an embodiment of a user interface 46 for enabling a user to configure employee statements. User interface 46 may be presented in response to the user selecting Configure Employee Statement 42 or by other selection means. User interface 46, according to this embodiment, includes a Create button 48 allowing the user to create a Statement Group, where the Statement Group is a grouping of one or more statement templates. The user can either create a new statement group or can make use of previously defined statement groups using a drop down list. (Observe down arrow before Create button 48.) The templates attached to the Statement Group can be made available for use after passing the check for readiness, as described below with respect to FIG. 5. When Create button 48 is selected, the user can enter the Statement Group, e.g., “Global Salary Change 2009”, as is illustrated.

Near the bottom of user interface 46 is a table allowing the user to select or create templates. The compensation administrator can use any of multiple templates to create a Statement Group, which can give the user, e.g., manager, flexibility to use different templates for different employees if needed. In some embodiments, the table includes a readiness column, allowing the user to initiate a readiness check on a selected template when desired. In other embodiments, the readiness check can be performed automatically.

FIG. 5 is a diagram illustrating the embodiment of user interface 46 of FIG. 4 and further illustrating an embodiment of an error window 52 superimposed over user interface 46. Error window 52 according to this example notifies the user of an incorrect template or template that does not meet all the required qualification for passing the check for readiness. In this particular case, the template is identified as having “no closing tag”. In addition, error window 52 suggests an action of how the template can be fixed. In response to such an error message, the user can return to the template creation procedures to modify the template accordingly to conform the template to the readiness criteria. When the statements are configured again, an additional errors may be presented. However, if it is avowed that the template is ready, either a message can be presented to the user indicating that the template is ready or the statement can be completed using the entered information as desired.

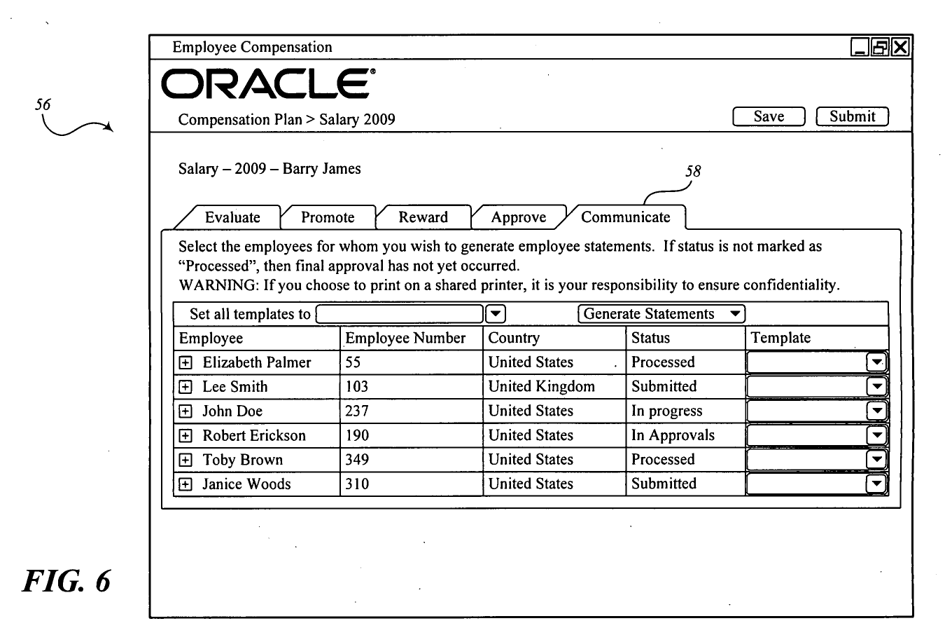

FIG. 6 is a diagram illustrating an embodiment of a user interface 56 for enabling a user to perform certain compensation functions for one or more employees. For example, several tabs can be selected allowing a manager or other user to “Evaluate”, “Promote”, “Reward”, “Approve”, or “Communicate”. In this respect, the manager can evaluate the compensation of the employees under the manager, promote one or more employees under the manager, and reward one or more employees with a bonus. Before these actions can be done, another manager or administrator may receive a request for such actions from the first manager. If appropriate, this manager or administrator can approve the action.

In the embodiment of FIG. 6, for example, a “Communicate” tab 58 is included. When selected, a user is able to generate employee statements for one or more employees, wherein the employee statements can be sent to the respective employees to communicate any compensation changes for the employee. This may be configured to be applicable only after the compensation change has been approved by the appropriate personnel.

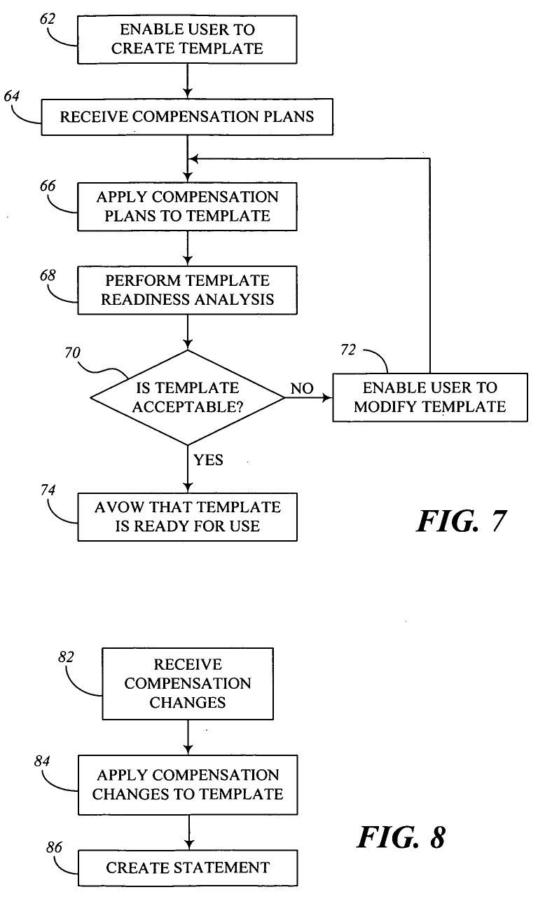

FIG. 7 is a flow diagram illustrating an embodiment of a method for setting up compensation templates. According to block 62, a user is enabled to create a template. In particular, the template may include a letter or statement intended to be communicated to an employee to indicate any compensation changes for the employee. For example, the compensation changes may include an increased salary, a bonus amount, or both.

As indicated in block 64, compensation plans are received. The compensation plans can be received, for example, from a compensation administrator or any other qualified user. As indicated in block 66, the compensation plans are applied to the template, which is created with respect to block 62 as mentioned above. In some embodiments, the compensation plans may be hypothetical plans for the purpose of checking the operability of the template under certain conditions. After applying the compensation plans to the template, a template readiness analysis is performed as indicated in block 68. Particularly, the template readiness analysis is performed on the template with the compensation plans applied thereto to check the readiness of the template.

As indicated in decision block 70, it is determined whether or not the template is acceptable. The acceptable may be based on the template readiness analysis mentioned with respect to block 68. If it is determined that the template is not acceptable, then the method proceeds to block 72. According to block 72, the user is enabled to modify the template. Based on errors detected, suggestions can be presented to the user to allow the user to make appropriate changes to fix the template. After further modification by the user, the flow returns back to block 66 where the compensation plans are applied to the template again. The processes are repeated until it is determine in decision block 70 that the template is acceptable. At this point, the method proceeds to block 74, which indicates that it is avowed that the template is ready for use.

FIG. 8 is a flow diagram of an embodiment of a method describing the templates in use. Specifically, the templates described in FIG. 8 refer to those templates that have been avowed as acceptable. For instance, the templates may be avowed as acceptable by the method described with respect to FIG. 7 or any other suitable method for determining the acceptability of the template.

According to the embodiment of FIG. 8, compensation changes are received as indicated in block 62. In some embodiments, the compensation changes can be received from a manager who wishes to communicate compensation changes to one or more employees under the manager's supervision. According to block 64, the compensation changes are applied to a compensation template. The compensation template can be a letter or statement and may include certain conditions based on the particular compensation changes being made. As indicated in block 66, an appropriate statement is created from the combination of the compensation changes and the template. The statement represents a communication medium for communicating the compensation change to the respective employee. The statement can be recorded by the employee for the purpose of creating a history of compensation changes with the organization.

It should be understood that the steps, processes, or operations described herein may represent any module or code sequence that can be implemented in software or firmware. In this regard, these modules and code sequences can include commands or instructions for executing specific logical steps, processes, or operations within physical components. It should further be understood that one or more of the steps, processes, and/or operations described herein may be executed substantially simultaneously or in a different order than explicitly described, as would be understood by one of ordinary skill in the art.

The embodiments described herein represent a number of implementations and examples and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

We claim:

1. An employee compensation module stored on a computer-readable medium and executable by a processing device, the employee compensation module comprising:
logic adapted to enable a user to create a proposed template for communicating compensation changes to one or more employees;
logic adapted to apply information regarding compensation changes to the proposed template; and
logic adapted to determine the readiness of the proposed template.

2. The employee compensation module of claim 1, wherein the logic adapted to determine the readiness of the proposed template is configured to base the determination of readiness on whether or not any errors exist when the information is applied to the proposed template.

3. The employee compensation module of claim 1, further comprising logic adapted to create a letter from the template and applied information.

4. The employee compensation module of claim 1, wherein the applied information includes hypothetical information for checking the readiness of the proposed template.

5. The employee compensation module of claim 1, wherein if the logic adapted to determine readiness determines that the proposed template is not ready, the logic adapted to enable the user to create the proposed template is further configured to enable the user to modify the proposed template.

6. The employee compensation module of claim 1, wherein if the logic adapted to determine readiness determines that the proposed template is ready, the logic adapted to determine readiness is further configure to avow to the user that the template is ready.

7. The employee compensation module of claim 6, further comprising logic adapted to set-up a compensation statement, the logic adapted to set-up the compensation statement configured to receive compensation changes regarding a particular employee from a second user, apply the compensation changes to the template, and create a compensation statement communicating the compensation changes to the particular employee.

8. The employee compensation module of claim 1, wherein the user is a compensation administrator.

9. A template managing module comprising:
a template creating module configured to enable a user to create a template to be considered for readiness;
a statement set-up module configured to receive the template to be considered and information to be applied to the template, the statement set-up module further configured to combine the template and information; and
a template readiness analyzing module configured to review the combination of the template and information to determine the readiness of the template for use by one or more other users.

10. The template managing module of claim 9, wherein, when the template readiness analyzing module determines that the template is not ready, the template creating module enables the user to modify the template as needed.

11. The template managing module of claim 9, wherein, when the template readiness analyzing module determines that the template is ready, the template readiness analyzing module avows to the user that the template is ready.

12. The template managing module of claim 9, wherein, when the template readiness analyzing module determines that the template is ready, the statement set-up module enables another user to enter information about an employee and request a statement.

13. The template managing module of claim 12, wherein, in response to receiving the request for the statement, the statement set-up module is configured to combine the information and the template to form a statement intended to communicate the information to the employee.

14. The template managing module of claim 9, wherein the template managing module is part of an employee compensation managing system, and wherein the information combined with the template includes information regarding compensation changes for an employee.

15. The template managing module of claim 14, wherein the statement set-up module is further configured to generate a statement communicating the employee's compensation changes.

16. The template managing module of claim 14, wherein the information is entered by a compensation administrator.

17. A method comprising:
applying information, which is received for the purpose of filling blank portions of a proposed template, into the proposed template; and
performing a readiness analysis on the proposed template to determine whether or not the proposed template is ready to be used by one or more users based on the application of the information into the proposed template.

18. The method of claim 17, wherein the information includes hypothetical information.

19. The method of claim 17, wherein performing the readiness analysis comprises determining whether one or more errors exist in the template when the information is applied.

20. The method of claim 17, wherein the method further comprises enabling a user to modify the proposed template when the readiness analysis determines that the proposed template is not ready to be used.

21. The method of claim 17, wherein the method further comprises enabling the one or more users to apply information regarding compensation changes of an employee to the template to create a statement communication the compensation changes to the employee.
